(19) United States
(12) Patent Application Publication
(10) Pub. No.: US 2014/0122793 A1
(43) Pub. Date: May 1, 2014

(54) MAGNETIC DISK DEVICE AND DATA WRITING METHOD

(71) Applicant: Kabushiki Kaisha Toshiba, Tokyo (JP)

(72) Inventor: Hiroaki INOUE, Kanagawa (JP)

(21) Appl. No.: 13/915,519

(22) Filed: Jun. 11, 2013

(30) Foreign Application Priority Data
Oct. 25, 2012 (JP) 2012-235627

(51) Int. Cl. G06F 12/08; G06F 3/06

(52) U.S. Cl. CPC G06F 12/0804; G06F 3/0676
USPC 711/112

(57) ABSTRACT

A magnetic disk device has a magnetic head, a magnetic disk that includes a plurality of data regions and a plurality of media cache regions associated with the data regions, and a controller configured to control the magnetic head to write data received from an external device in the media cache regions and then write back the data written in the media cache regions to the data regions associated with the media cache regions.

### CROSS-REFERENCE TO RELATED APPLICATION(S)

This application is based upon and claims the benefit of priority from Japanese Patent Application No. 2012-235627, filed on Oct. 25, 2012, the entire contents of which are incorporated herein by reference.

### FIELD

Embodiments of the present application relate to a magnetic disk device and a data writing method.

### BACKGROUND

A method of writing data randomly in a magnetic disk device has been introduced in which the data corresponding to write command is temporarily written in a buffer memory provided at a periphery of the magnetic disk before writing the data in the magnetic disk. In this method, the data written in the buffer memory is reorganized and the sequence of the data to be written is changed so that the time needed to rotate the magnetic disk and seek the position in the disk to write the data can be shortened. Since the time to rotate the disk and seek the position is shortened, the entire time needed to write the data in the magnetic disk can be shortened at least to the extent that the shortened time is longer than the time needed to calculate the sequence.

### BRIEF DESCRIPTION OF THE DRAWINGS

FIG. 1 is a block diagram of a schematic configuration of a magnetic disk device according to one embodiment.

FIG. 2A is a plan view of a magnetic disk of FIG. 1 showing a track arrangement of the magnetic disk.

FIG. 2B is a conceptual diagram showing an example configuration of a data area DA shown in FIG. 2A.

FIG. 3A is a plan view of the magnetic disk of FIG. 1 showing an example of how logical block addresses are allocated in the magnetic disk.

FIG. 3B is a conceptual diagram showing an example of a media cache region MC1 shown in FIG. 2B within a logical address space.

FIG. 3C is a chart showing an example of media cache management data stored in a media cache management region DM shown in FIG. 2B.

FIG. 4 is a flow diagram of a method for writing data in a media cache in the magnetic disk device of FIG. 1.

FIG. 5 is a flow diagram of a method for distributing data to be written in the media cache to a plurality of media cache regions in the magnetic disk device of FIG. 1.

FIG. 6 is a flow diagram of a method for writing back the data written in the media cache regions to the data regions of the magnetic disk device of FIG. 1.

FIG. 7 is a graph that shows a relationship between the number of queued commands and the random writing ability of the magnetic disk device of FIG. 1.

### DETAILED DESCRIPTION

A magnetic disk device disclosed in the application has a magnetic head, a magnetic disk that includes a plurality of data regions and a plurality of media cache regions associated with the data regions, and a controller configured to control the magnetic head to write data received from an external device in the media cache regions and then write back the data written in the media cache regions to the data regions associated with the media cache regions.

Hereinafter, the magnetic disk device according to the embodiments is explained in detail with reference to the drawings. However, the present application is not limited to the specific configuration of the embodiments.

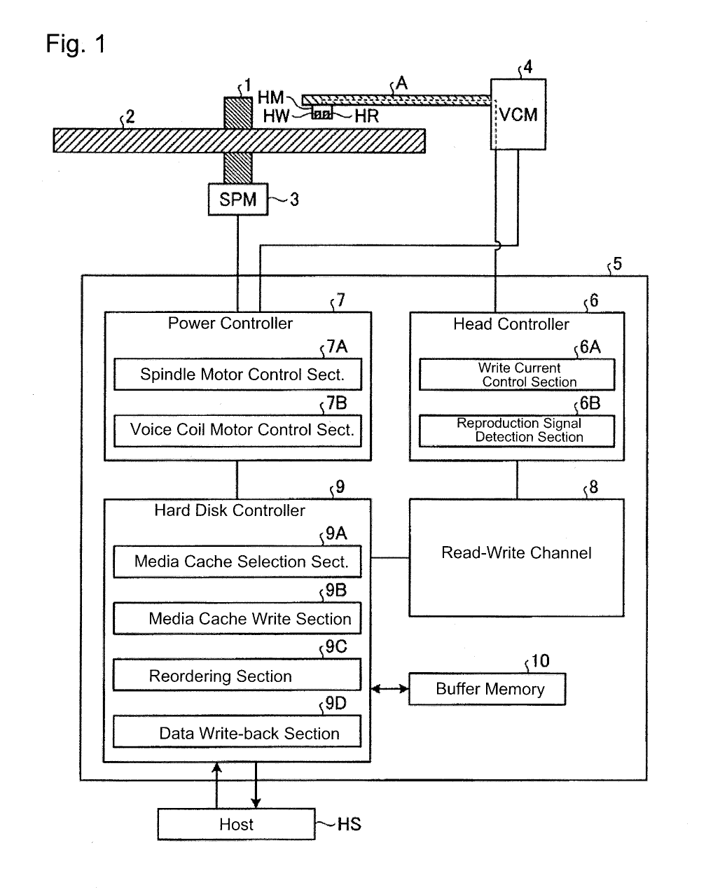

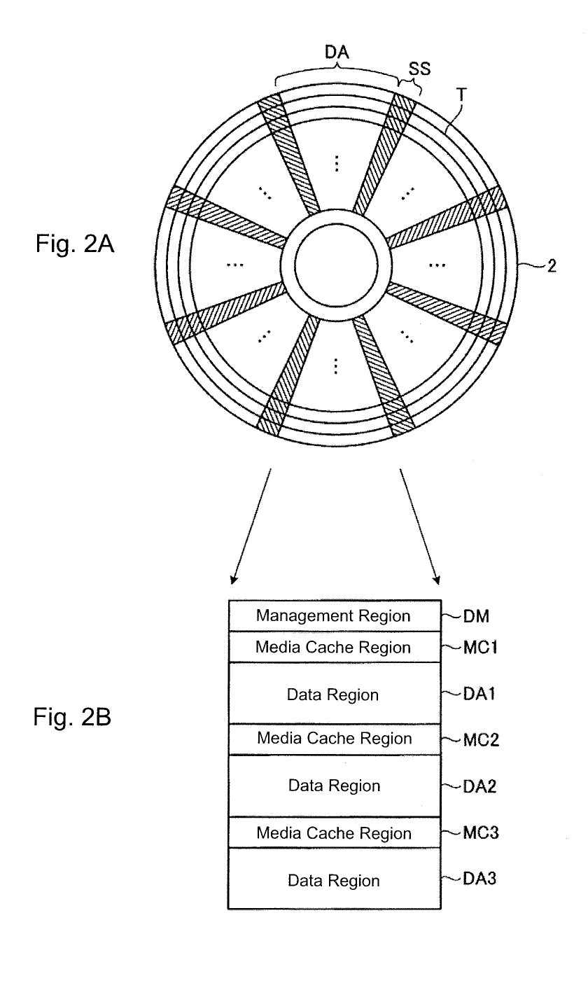

FIG. 1 is a block diagram of a schematic configuration of a magnetic disk device according to one embodiment. FIG. 2A is a plan view of a magnetic disk of FIG. 1 showing an example of a track arrangement of the magnetic disk. FIG. 2B is a conceptual diagram showing an example of a configuration of a data area DA of FIG. 2A.

In FIG. 1, the magnetic disk device includes a magnetic disk 2, which is supported by a spindle 1. Also, the magnetic disk device includes a magnetic head HM, which comprises a write head HW and a read head HR. The write head HW and the read head HR are arranged to face the magnetic disk 2. The magnetic head HM is held on the magnetic disk 2 by an arm A. The arm A is capable of sliding the magnetic head HM in a horizontal plane.

As illustrated in FIG. 2A, the magnetic disk 2 includes tracks T along a circumferential direction. Each of the tracks T includes a data area DA to which main data is written and a servo area SS in which servo data is written. The servo areas SS are radially disposed in the magnetic disk 2 and the data areas DA are disposed between the servo areas SS. In the servo area SS, servo data such as sector/cylinder data, a burst pattern, etc. can be recorded. For example, the sector/cylinder data provides a servo address in a circumferential direction and a radius direction of the magnetic disk 2 and the servo address is used for a seeking operation, in which the magnetic head HM is moved to a target track. The burst pattern is used for a tracking operation in which the magnetic head HM is positioned in a range of a target track. The servo data may be recorded to the magnetic disk 2 by self servo writing, or by a servo writer solely used for the servo data writing.

As illustrated in FIG. 2B, the data area DA includes data regions DA1 through DA3 to which write data (main data) is written. Also, the data area DA includes media cache regions MC1 through MC 3 to which write data is temporarily written. The media cache regions MC1 through MC3 respectively correspond to the data regions DA1 through DA3. In other words, data to be written to the data region DA1 can be temporarily written to the media cache region MC1, data to be written to the data region DA2 can be temporarily written to the media cache region MC2, and data to be written to the data region DA3 can be temporarily written to the media cache region MC3. Though the example of FIG. 2B shows the case in which the data area DA is divided into three data regions DA1 through DA3 and three media cache regions MC1 through MC3, the number of divisions is not limited to three, and may be two, or four or more. The media cache region MC1 is preferred to be disposed close to the data region DA1, in order to reduce the time to seek the data region DA1 when the data written in the media cache region MC1 is written back to the data region DA1. For the same reason, the media cache region MC2 is preferably disposed close to the data region DA2, and the media cache region MC3 is preferably disposed close to the data region DA3. Further, the data area DA includes a media cache management region DM. In the media cache management region DM, media cache management data is written. The media cache management data shows where data to be written to the data regions DA1 through DA3 is written in the media cache regions MC1 through MC3.

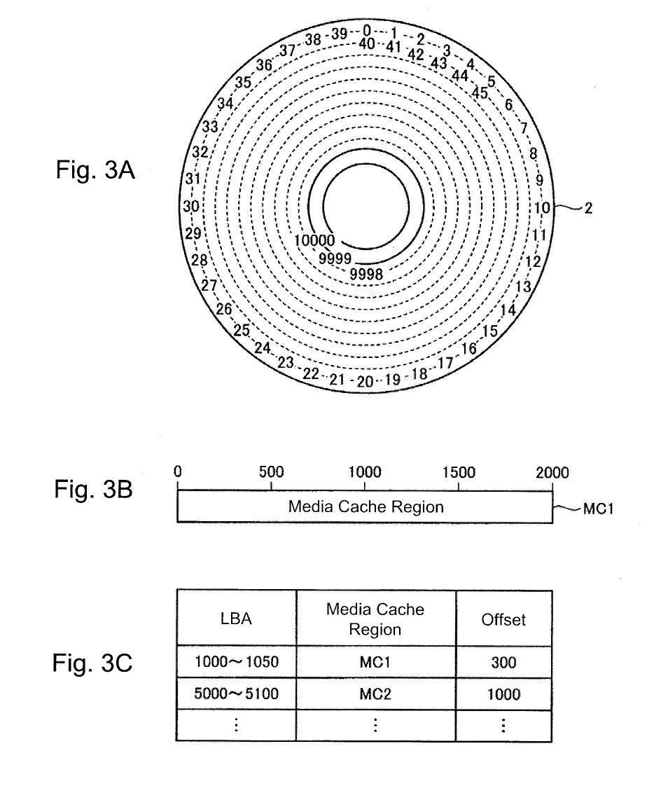

FIG. 3A is a plan view of the magnetic disk of FIG. 1 showing an example of an allocation of a logical block address in the magnetic disk. FIG. 3B is a conceptual diagram showing an example of a setting of an offset in a media cache region MC1 of FIG. 2B. FIG. 3C is a chart showing an example of media cache management data stored in the media cache management region DM of FIG. 2B.

In FIG. 3A, logical block addresses (LBA) are allocated to the magnetic disk 2. For example, as the LBAs, address 0 to address 10000 can be concentrically allocated from an outer circumference to an inner circumference. In this case, for example, address 0 to address 3333 correspond to the data region DA1, address 3334 to address 6666 correspond to the data region DA2, and address 6667 to address 10000 correspond to the data region DA3.

In FIG. 3B, an offset is allocated in the media cache region MC1, for example. For example, address 0 to address 2000 is allocated from the top to the last of the media cache region MC1.

In FIG. 3C, in the media cache management region DM, the media cache regions MC1 through MC3 and offsets are recorded. The media cache regions MC1 through MC3 correspond to LBA assigned by a write command.

In FIG. 1, the magnetic disk device includes a voice coil motor 4 that drives the arm A and a spindle motor 3 that rotates the magnetic disk 2 supported by the spindle 1.

Also, the magnetic disk device includes a magnetic recording controller 5. The magnetic recording controller 5 includes a head controller 6, a power controller 7, a read-write channel 8, a hard disk controller 9, and a buffer memory 10. The magnetic recording controller 5 is configured to control the magnetic head HM to write back the write data temporarily written to the media cache regions MC1 through MC3 to the data regions DA1 through DA3.

Also, the head controller 6 includes a write current control section 6A and a reproduction signal detection section 6B. The power controller 7 includes a spindle motor control section 7A and a voice coil motor control section 7B. The hard disk controller 9 includes a media cache selection section 9A, a media cache writing section 9B, a reordering section 9C, and a data write-back section 9D.

The head controller 6 amplifies and detects signals during recording and reproduction. Specifically, the write current control section 6A controls a write current flowing in the write head HW. Also, the reproduction signal detection section 6B detects signals read by the read head HR.

The power controller 7 drives the voice coil motor 4 and the spindle motor 3. Specifically, the spindle motor control section 7A controls rotation of the spindle motor 3. Also, the voice coil motor control section 7B controls driving of the voice coil motor 4.

The read-write channel 8 performs data reception and transmission between the head controller 6 and the hard disk controller 9. The data transmitted includes read data, write data, and servo data. In addition, the read-write channel 8 can convert the format of the signals reproduced by the read head HR into a data format compatible to a host HS and convert the format of the signals output from the host HS to a format by which the write head HW records data in the magnetic disk. Such format conversion includes a DA conversion and a coding. In addition, the read-write channel 8 can perform a decoding process of signals reproduced by the read head HR and performs code modulation of data output from the host HS.

The hard disk control part 9 performs recording and reproduction control based on an order from an external device and performs data reception and transmission between the external device and the read-write channel 8. Specifically, the media cache selection section 9A selects the media cache regions MC1 through MC3 based on the LBA assigned by the host HS. The media cache writing section 9B transmits the write data corresponding to a write command to the head controller 6 so that the write data is written in one of the media cache regions MC1 through MC3 selected by the media cache selection part 9A. The reordering section 9C reorders data written to the media cache regions MC1 through MC3. The data write-back section 9D is configured to write the reordered data back to the data regions DA1 through DA3 corresponding to the media cache regions MC1 through MC3, respectively, if data written to the media cache regions MC1 through MC3 accumulates to a predetermined amount or more.

The buffer memory 10 temporarily holds write data temporarily written to the media cache regions MC1 through MC3 before the write data temporarily written to the media cache regions MC1 through MC3 is written back to the data regions DA1 through DA3. For the buffer memory 10, semiconductor memories such as randomly accessible DRAM and SRAM, etc. can be used.

The magnetic recording controller 5 is connected to the host HS. For the host HS, a personal computer that provides a write command and a read command to the magnetic disk device or an external interface may be used.

The read head HR reads signals from the magnetic disk 2 while the magnetic disk 2 rotates, and the reproduction signal detection section 6B detects the signals that have been read. The signals detected by the reproduction signal detection section 6B is transmitted to the hard disk controller 9 after the signals are converted by the read-write channel 8. Then, the hard disk controller 9 performs tracking control of the magnetic head HM based on servo data included in the signals detected by the reproduction signal detection section 6B.

When the host HS provides a write command, the media cache selection section 9A selects one of the media cache regions MC1 through MC3 according to the LBA assigned by the write command. Then, the media cache writing section 9B writes the write data corresponding to the write command to the one of the media cache regions MC1 through MC3, which is selected by the media cache selection section 9A, and also writes media cache management data corresponding to the write command to the media cache management region DM. Here, the write command randomly assigns a writing position in the data regions DA1 through DA3. However, even though the writing position in the data regions DA1 through DA3 is randomly assigned, the write data corresponding to the write command is sequentially written in the media cache regions MC1 through MC3 corresponding to the LBA assigned by the write command. Since writing data sequentially requires the magnetic head HM to move and seek the writing position only one time, writing data sequentially in the region needs less time to write than randomly writing data in a plurality of parts in the region. Therefore, if the data is sequentially written to the media cache regions MC1 through MC3, time required for the magnetic head HM to move and seek the writing position can be shortened as compared to the case in which random writing is performed to the data regions DA1 through DA3.

The data write-back section 9D determines if data written to any of the media cache regions MC1 through MC3 accumulates to a predetermined amount or more. If write data written to any of the media cache regions MC1 through MC3 accumulates to the predetermined amount or more, the write data is transferred from the media cache region MC1 through MC3 to the buffer memory 10, and also media cache management data corresponding to the write data is transferred from the media cache management region DM to the buffer memory 10. The reordering section 9C reorders write data transferred to the buffer memory 10 based on the media cache management data that has been transferred. Then, the data write-back section 9D writes the data read from the buffer memory 10 to a writing position (LBA) assigned by the write command in the data regions DA1 through DA3.

Since a write command is temporarily held in the media cache regions MC1 through MC3, a capacity of the buffer memory 10 is reduced and this leads to cost saving. Further, the plurality of data regions DA1 through DA3 are formed in the magnetic disk 2 and the plurality of media cache regions MC1 through MC3 are provided in correspondence with the data regions DA1 through DA 3. This configuration enables the write-back of data in the media cache regions MC1 through MC3 only too one of the data regions DA1 through DA3 corresponding to the media cache regions MC1 through MC3, and narrows a range to which the written data is transferred. For example, for writing back the write data in the media cache region MC1, the write data needs to be written back only to the range of the data region DA1, and the write data do not need to be written back to the data regions DA2 and DA3. As a result, the magnetic head HM needs to move and seek the writing positions only within the range of the data region DA1. This increases the efficiency of writing back the write data from the media cache region MC1 through MC3 to the data regions DA1 through DA3, because less time is needed to move the magnetic head HM and seek the writing positions.

The data write-back section 9D may suspend the write-back of the write data to the data regions DA1 through DA3 if an amount of write data remaining in the media cache regions MC1 through MC3 is equal to or less than a predetermined amount after a part of the write data is written back from the media cache regions MC1 through MC3 to the data regions DA1 through DA3. Also, the media cache writing section 9B may rewrite the remaining write command to the media cache regions MC1 through MC3 so that the data is packed in a part of each media cache region if the transfer of the write data to the data regions DA1 through DA3 is suspended.

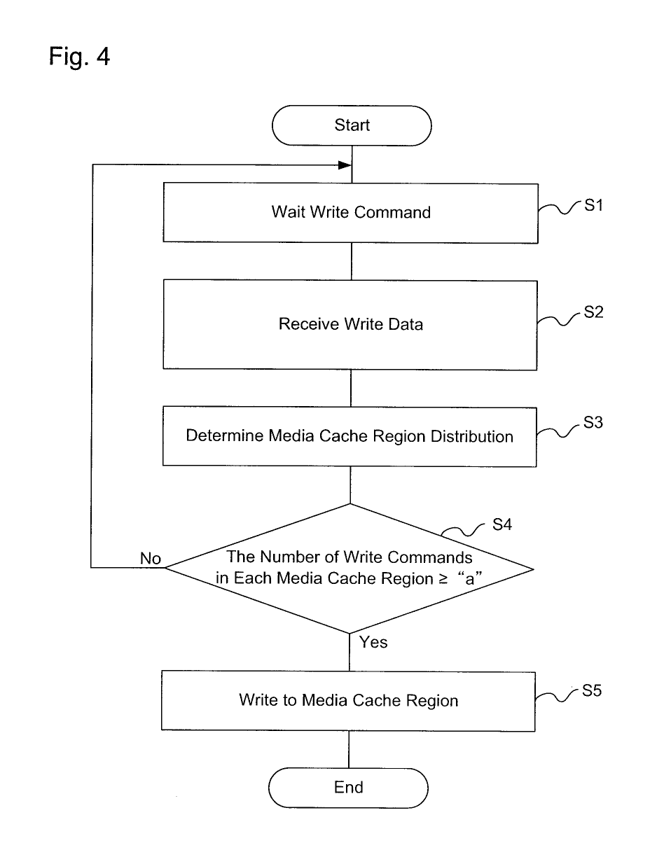

FIG. 4 is a flow diagram of a method for writing write data in a media cache in the magnetic disk device of FIG. 1.

In FIG. 4, the magnetic recording controller 5 waits for the host HS provides a write command (S1). If the host HS outputs a write command, the magnetic recording controller 5 receives the write command, in which a write data is included (S2). Then, the magnetic recording controller 5 distributes the write data to the media cache regions MC1 through MC3 based on the LBA assigned by the write command (S3).

Then, if the number of write commands in any of the media cache regions MC1 through MC3 is “a” (“a” is a positive integer) or more (Yes in S4), the write commands are written to the media cache regions MC1 through MC3 (S5). On the other hand, the number of write commands in any of the media cache regions MC1 through MC3 does not reach “a” (No in S4), the operation process returns back to S1 and repeats the operations of S1 through S4.

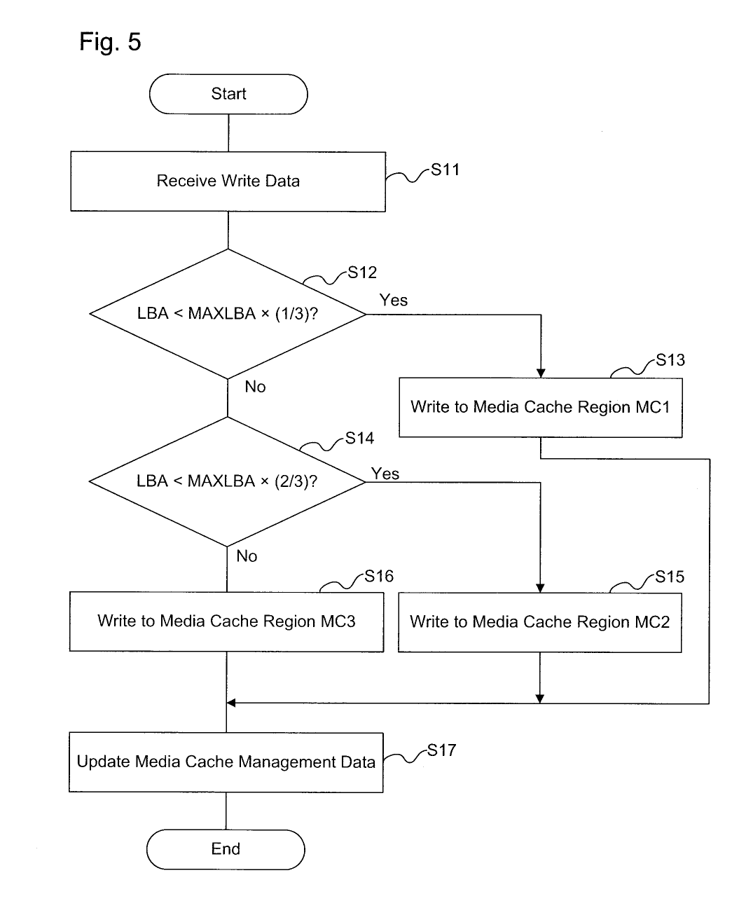

FIG. 5 is a flow diagram of a method for distributing the data to be written in the media cache to the media cache regions MC1 through MC3 in the magnetic disk device of FIG. 1.

In FIG. 5, if the magnetic recording control part 5 receives the write data (S11), then it determines where to distribute the write data based on the LBA assigned by the write command. If the LBA assigned by a write command is less than “a maximum value of LBA (MAXLBA)×⅓” (Yes in S12), the write data is written to the media cache region MC1 (Yes in S13). If the LBA assigned by a write command is “MAXLBA×⅓” or more (No in S12) and less than “MAXLBA×⅔” (Yes in S14), the write data is written to the media cache region MC2 (S15). If the LBA assigned by a write command is “MAXLBA×⅔” or more (No in S 14), the write data is written to the media cache region MC3 (S16). Thereafter, media cache management data is updated according to the state of the media cache regions MC1 through MC3 (S17).

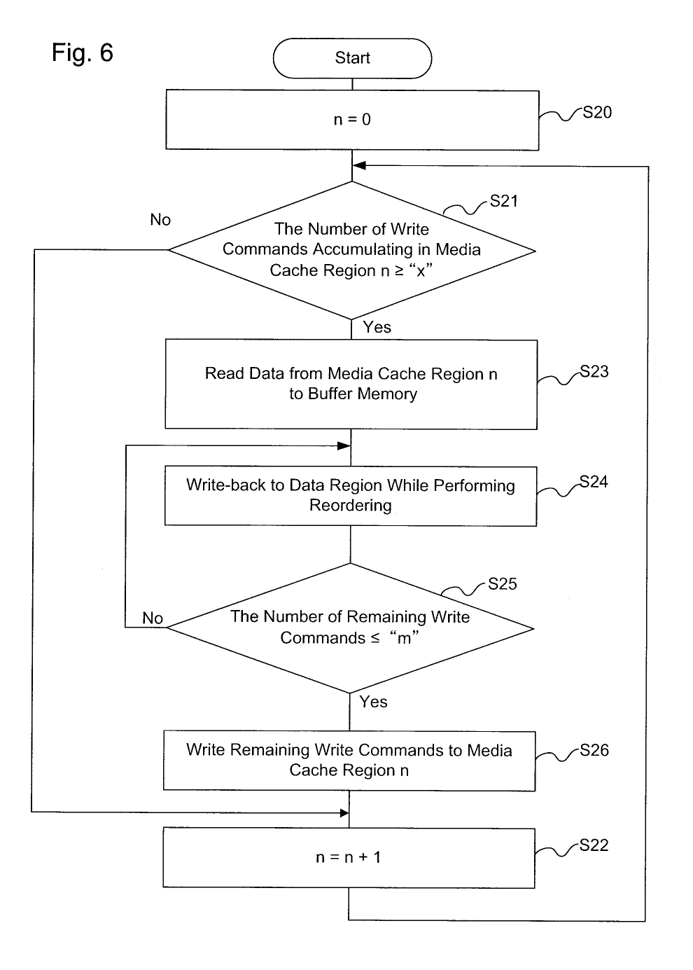

FIG. 6 is a flow diagram of a method for writing back the write data written in the cache regions to be data regions of the magnetic disk device of FIG. 1.

In FIG. 6, the value of “n” is the number of the media cache region from which the write data is written back in the operation. Thus, if n=1, for example, it shows that the write data will be written back from the media cache region MC1. In FIG. 6, after setting as “n=1” (S20), it is determined whether or not “x” (“x” is a positive integer) or more write commands have accumulated in a media cache region n (S21). If “x” or more write commands have not accumulated in the media cache region n (No in S21), “n” is incremented by one (S22), and the process returns to S21. Here, “x” can be set to obtain the most efficient write-back of the write data to the data regions based on the effectiveness of the reordering of the write data.

On the other hand, if “x” or more write commands have accumulated in the media cache region n (Yes in S21), the write data is transferred from the media cache region n to the buffer memory 10 (S23). Then, while the write data is reordered, the write data is read from the buffer memory 10 and is written back to the data region corresponding to the media cache region n (S24).

At this moment, if the amount of the write commands remaining in the media cache region n is “m” (“m” is a positive integer) or less after the write data is transferred to the data region from the media cache region n (Yes in S25), the write-back of the write data is suspended. Then, the remaining write commands are rewritten to the media cache region n so that the remaining write commands are packed in a part of the media cache region (S26). Then, “n” is incremented by one (S22), and the operation process returns to S21. On the other hand, if the amount of the write commands remaining in the media cache region n is in excess of “m” (No in S25), the process returns to S24, and the write data is written back to the data region corresponding to the media cache region n.

Thus, if the amount of the write commands remaining in the media cache region n is “m” or less, the write-back of the write data to the data region is suspended. Due to suspending the write-back of the write data, the write-back of the write data can be performed with the efficiency of the reordering maintained. Also, by rewriting the remaining write commands so that the write commands are packed in a part of the media cache region n, the management of the media cache management region DM is simplified.

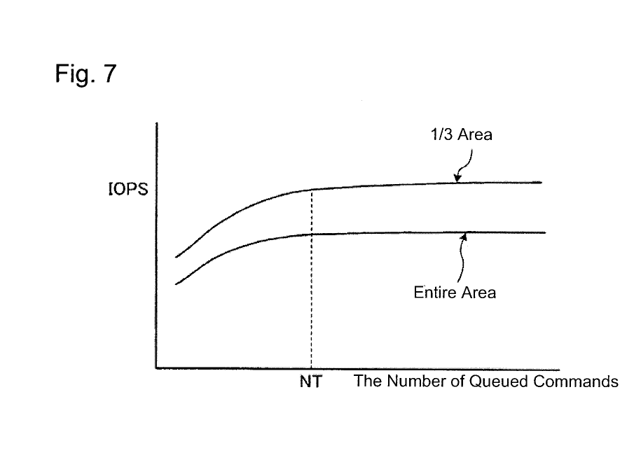

FIG. 7 is a chart that shows a relationship between the number of queued commands and the random writing ability. Here, the random writing ability is indicated using input/output operations per second (IOPS), which is the number of commands that can be written per second). For reordering random writing, it is required to calculate the positional relationship of the magnetic head HM and the magnetic disk 2 and the moving time of the magnetic head HM for the number of times of queued commands and to seek write command of the most efficient way to move the magnetic head HM. Therefore, in order to reduce the time for waiting rotation and to efficiently move the magnetic head HM, it is effective to increase the number of queued commands at a time. However, as the number of queued commands increases, the time required for the calculation of reordering increases. Thus, the random writing ability saturates at a certain point. For this reason, in order to reduce the time required for the calculation of reordering, it is effective to narrow the area in which the magnetic head HM moves by dividing the data region into three data regions DA1 through DA3.

In FIG. 7, the random writing ability in the case of dividing the data region into three data regions DA1 through DA3 (the characteristic shown by “⅓ area” in FIG. 7) is superior to the random writing ability in the case of writing the data in the entire area without limiting an area to which the data is written (the characteristic shown by “entire area” in FIG. 7). As shown in FIG. 7, if the number of queued commands is extremely small, the random writing ability is lower. Also, if the number of queued commands is certain number (NT) or more, the random writing ability is almost constant. This is because the processing ability of a CPU that performs the reordering has reached the limit. Therefore, it is preferred to write back the write data from the media cache region n to the data region if the number of queued commands is NT or more, and it is preferred to suspend the write-back of the write data to the data region if the number of queued commands is less than NT. For example, the number of queued commands NT can be set to be 100 if the data regions are divided into three regions. Also, the number of queued commands NT may be changed according to the number of divisions of the data region.

While certain embodiments have been described, these embodiments have been presented by way of example only; and are not intended to limit the scope of the inventions. Indeed, the novel embodiments described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirits of the inventions.

What is claimed is:

1. A magnetic disk device, comprising:
a magnetic head;
a magnetic disk comprises a plurality of data regions and a plurality of media cache regions associated with the data regions; and
a controller configured to control the magnetic head to write data received from an external device into one of the media cache regions and then write back the data written in the one of the media cache regions into one of the data regions associated with the one of the media cache regions.

2. The magnetic disk device according to claim 1, wherein
the controller includes a selection section that is configured to select one of the media cache regions based on a logical block address corresponding to the write data designated by the external device, and
the magnetic head is configured to write back the data in the media cache region selected by the selection section.

3. The magnetic disk device according to claim 2, wherein
the data is sequentially written in the media cache regions.

4. The magnetic disk device according to claim 2, wherein
the controller includes a reordering section that is configured to reorder the data written in the media cache regions, and
the magnetic head is configured to write back the reordered data into the data regions.

5. The magnetic disk device according to claim 4, wherein
the reordering section is configured to reorder the data written in the media cache regions so that time for which the magnetic head moves to write back the data into the data regions is minimized.

6. The magnetic disk device according to claim 4, wherein
the controller is configured to suspend writing back the data in the media cache regions into the data regions if the amount of data that is remaining in the media cache regions is equal to or less than a predetermined amount.

7. The magnetic disk device according to claim 4, wherein
the controller is configured to temporarily hold the data written in the media cache regions into a buffer memory before writing back the data into the data regions.

8. The magnetic disk device according to claim 7, wherein
the controller is configured to control the magnetic head to read the data written in the media cache regions and store the data in the buffer memory, and
the reordering section is configured to reorder the data stored in the buffer memory.

9. The magnetic disk device according to claim 7, wherein
the controller is configured to control the magnetic head to read the data written in the media cache regions and stored the data in the buffer memory if the amount of data written in the media cache regions is equal to or greater than a predetermined number.

10. The magnetic disk device according to claim 6, wherein
the controller is configured to control the magnetic head to rewrite the data remaining in the media cache regions so that the remaining data is compacted in the media cache regions.

11. A method for writing data in a magnetic disk that includes a plurality of data regions to which data is written and a plurality of media cache regions associated with the data regions, comprising:
writing into the media cache regions, write data received from an external device; and
writing back the data written in the media cache regions into the data regions associated with the media cache regions.

12. The method according to claim 11, further comprising:
selecting one of the media cache regions based on a logical block address of the data regions designated by the external device, so that the write data is written in the selected media cache region.

13. The method according to claim 12, wherein
the data is sequentially written in the media cache regions.

14. The method according to claim 12, further comprising:
reordering the data written in the media cache regions, wherein the reordered data is written back into the data regions.

15. The method according to claim 12, further comprising
reordering the data written in the media cache regions so that time to write back the data into the data regions is minimized.

16. The method according to claim 11, further comprising:
suspending the writing back of the data in the media cache regions into the data regions if the amount of data that is remaining in the media cache regions is equal to or less than a predetermined amount.

17. The method according to claim 11, further comprising:
temporarily holding the data written in the media cache regions into a buffer memory before writing back the data into the data regions.

18. The method according to claim 17, further comprising:
reordering the data stored in the buffer memory.

19. The method according to claim 11, further comprising:
temporarily holding the data written in the media cache regions into a buffer memory if the amount of data written in the media cache regions is equal to or greater than a predetermined number.

20. The method according to claim 16, further comprising:
rewriting the data remaining in the media cache regions so that the remaining data is compacted in the media cache regions.
